(19) United States
(12) Patent Application Publication
(10) Pub. No.: US 2011/0285596 A1
(43) Pub. Date: Nov. 24, 2011

(54) INDUCTIVELY COUPLED BAND SELECTABLE AND TUNABLE ANTENNA

(75) Inventor: Steve Krupa, Haifa (IL)

(73) Assignee: GALTRONICS CORPORATION LTD., Tiberias (IL)

(21) Appl. No.: 13/139,617

(22) PCT Filed: Dec. 13, 2009
(86) PCT No.: PCT/IL09/01180

§ 371 Date: Aug. 12, 2011

(30) Foreign Application Priority Data
Dec. 15, 2008 (US) 61/201862

(51) Int. Cl. H01Q 7/00; H01Q 1/36

(52) U.S. Cl. 343/748; 343/745

(57) ABSTRACT

An inductively coupled band selectable and tunable antenna, the antenna including a first conductive segment, a second conductive segment interleaved with the first conductive segment and inductively coupled to the first conductive segment, band selection hardware located along the first conductive segment and tuning hardware located along the second conductive segment.

### REFERENCE TO RELATED APPLICATIONS

The present application is related to U.S. Provisional Patent Application Ser. No. 61/201,862, filed Dec. 15, 2008, and entitled INDUCTIVELY COUPLED BAND SELECTABLE AND TUNABLE ANTENNA, the disclosure of which is hereby incorporated by reference and priority of which is hereby claimed pursuant to 37 CFR 1.78(a) (4) and (5)(i).

### FIELD OF THE INVENTION

The present invention relates generally to antennas and more particularly to inductively coupled antennas capable of having their bands of operation selected and tuned.

### BACKGROUND OF THE INVENTION

The following Patent documents are believed to represent the current state of the art:

U.S. Pat. Nos. 5,072,233, 7,061,440 and 7,164,387.

### SUMMARY OF THE INVENTION

The present invention seeks to provide an improved inductively coupled band selectable and tunable antenna design topology whereby the antenna is capable of providing optimal radiation efficiency at a range of operating frequencies and of compensating for disruptive operating conditions.

There is thus provided in accordance with a preferred embodiment of the present invention an inductively coupled band selectable and tunable antenna including a first conductive segment, a second conductive segment interleaved with the first conductive segment and inductively coupled to the first conductive segment, band selection hardware located along the first conductive segment and tuning hardware located along the second conductive segment.

In accordance with a preferred embodiment of the present invention, the first conductive segment has a loop structure. Additionally or alternatively, the second conductive segment has a loop structure.

Preferably, the first and second conductive segments include three-dimensional coils.

In accordance with another preferred embodiment of the present invention, the second conductive segment has a monopole structure.

Preferably, the first and second conductive segments are printed on a printed circuit board.

Preferably, the band selection hardware includes at least one radio frequency switch.

Preferably, the tuning hardware includes at least one variable capacitor.

Preferably, the strength of the inductive coupling between the first conductive segment and the second conductive segment is controlled by the geometry of the interleaved portions of the first and second conductive segments.

Preferably, the antenna is fed by a feed located at the start of the first conductive segment.

Preferably, the first conductive segment is galvanically isolated from the second conductive segment.

### BRIEF DESCRIPTION OF THE DRAWINGS

The present invention will be understood and appreciated more fully from the following detailed description, taken in conjunction with the drawings in which:

FIG. 1 is a simplified circuit diagram of the components of an antenna constructed and operative in accordance with a preferred embodiment of the present invention, the antenna including primary and secondary segments inductively coupled by primary and secondary inductive coupling portions;

FIG. 2 is a top view illustration of the antenna of FIG. 1 formed in two dimensions on a printed circuit board, the antenna including primary and secondary inductively coupled conductive segments both having a loop structure;

FIG. 3 is a top view illustration of the antenna of FIG. 1 formed in two dimensions on a printed circuit board, the antenna including primary and secondary inductively coupled conductive segments, the primary segment having a loop structure and the secondary segment having a monopole structure; and

FIG. 4 is a side view illustration of the antenna of FIG. 1 formed in three dimensions on a dielectric substrate, the antenna including primary and secondary inductively coupled conductive segments both having a coiled loop structure.

### DETAILED DESCRIPTION OF PREFERRED EMBODIMENTS

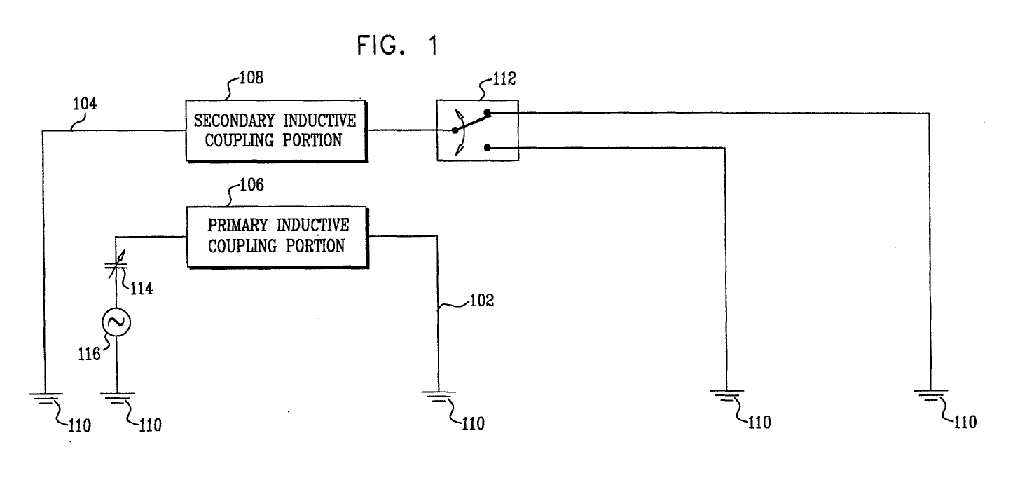

Reference is now made to FIG. 1, which is a simplified circuit diagram of the components of an antenna constructed and operative in accordance with a preferred embodiment of the present invention, the antenna including primary and secondary segments inductively coupled by primary and secondary inductive coupling portions.

As seen in FIG. 1 the antenna comprises two conductive segments: a primary segment 102 and a secondary segment 104. Primary segment 102 includes a primary inductive coupling portion 106 and secondary segment 104 includes a secondary inductive coupling portion 108. The primary and secondary segments 102 and 104 are each in contact with the antenna ground 110.

Band selection hardware 112 is preferably located along secondary segment 104. In the embodiment shown in FIG. 1 the band selection hardware 112 is in the form of a switch although various other embodiments are also possible. An in-band tuning device 114 is preferably located along primary segment 102. In the embodiment shown in FIG. 1 the in-band tuning device is in the form of a variable capacitor although various other embodiments are also possible.

The antenna is fed by a single feed 116 preferably located at the start of the primary segment 102. A conventional discrete passive component matching circuit (not shown) within the feed 116 may be beneficial to the functioning of the antenna.

Primary segment 102 and secondary segment 104 are preferably galvanically isolated from each other and inductively coupled by their respective primary and secondary inductive coupling portions 106 and 108. Primary and secondary inductive coupling portions 106 and 108 are preferably in the form of interleaved portions of primary and secondary segments 102 and 104. The impedance match of the antenna structure is controlled by the intensity of the inductive coupling between the primary and secondary segments which intensity is in turn influenced by the geometric characteristics of the interleaved features of primary and secondary inductive coupling portions 106 and 108.

The band selection hardware 112 determines the band of operation of the antenna, preferably by effectively shortening or lengthening the length of the active conducting path of the secondary segment 104. In the embodiment shown in FIG. 1 two alternate paths for completing the loop structure of the secondary segment 104 are available, although more are obviously possible. As seen in FIG. 1, these two alternate conducting paths constitute a significant proportion of the total radiating length of secondary segment 104. The difference in the lengths of the alternate conducting paths may be substantial, for example as in the case where the antenna host device requires multiple frequency bands of operation separated by several hundred megahertz of unused bandwidth.

Those portions of the secondary segment 104 which are omitted from the conducting path due to positioning of band selection hardware 112 preferably have little effect on the radiating characteristics of those portions of the secondary segment 104 which are included in the conductive path. This facilitates adjustment between highly disparate bands of operation without compromising the radiation efficiency within any of the bands.

The in-band tuning device 114 is preferably located at a key point along the primary segment 102. It is appreciated that although only a single in-band tuning device 114 is illustrated in the embodiment shown in FIG. 1, the use of multiple in-band tuning devices is possible. The in-band tuning device 114 may be positioned in-line with the primary segment 102, as shown in the embodiment illustrated in FIG. 1 or alternatively or additionally placed in ‘shunt’ with one end galvanically connected to the antenna ground. The in-band tuning device 114 is preferably selectively placed at a position or positions that maximize the realizable tunable range over the permissible limits of the control signals, which control signals typically comprise adjustable DC bias voltages.

Location of the in-band tuning device 114 along the secondary segment 104 is also theoretically possible although extra device components beyond those illustrated in FIG. 1 would be required in order to provide the necessary control signals.

In those cases where the in-band tuning device 114 generates intermodulation products beyond the permissible limits of the antenna host device, the in-band tuning device 114 may be installed in a topology that minimizes the net intermodulation products, thereby satisfying the design specification of the host device.

The antenna of FIG. 1 may be realized over a wide range of operating frequencies and device applications including FM, DVB-H, RFID, cellular communications, WiFi and WiMax.

The antenna of the present invention, due to its intentionally narrow and selective effective operating bandwidth, provides improved out-of-band noise rejection. This may permit the use of less selective or fewer band-pass filters in the antenna's transmission path. Similarly, the antenna of the present invention is capable of compensating for disruptive operating conditions by way of adjustment of its operating band and resonant frequency.

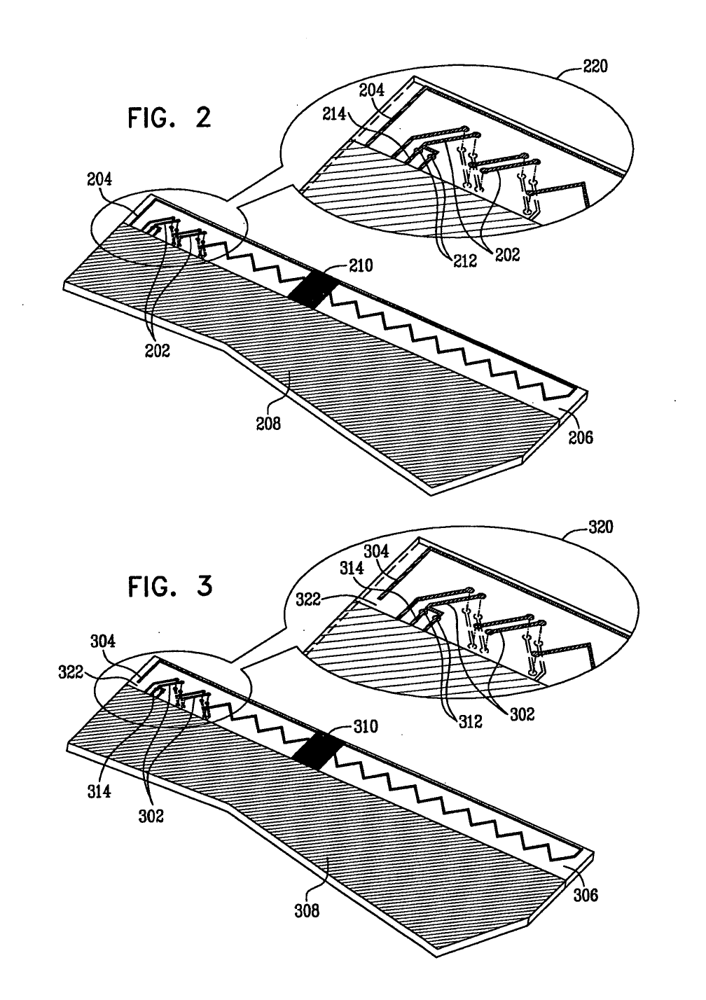

Reference is now made to FIG. 2, which is a top view of the antenna of FIG. 1 formed in two dimensions on a printed circuit board, the antenna including primary and secondary inductively coupled conductive segments both having a loop structure.

As seen in FIG. 2, the antenna comprises two conductive segments: primary segment 202 and secondary segment 204. Primary and secondary segments 202 and 204 are printed on a printed circuit board (PCB) substrate 206 and are each in contact with a PCB ground 208.

Band selection hardware 210 is preferably located along secondary segment 204. In-band tuning devices 212 are preferably located along primary segment 202. The operation of band selection hardware 210 and in-band tuning devices 212 is as described in reference to the parallel features of FIG. 1.

The antenna is fed by a single feed 214 preferably located at the start of the primary segment 202.

Primary segment 202 and secondary segment 204 preferably share a common placement axis running substantially parallel to one of the edges of the PCB substrate 206. It is appreciated that other topologies featuring offset or angled element orientations are also possible. Primary segment 202 is preferably embodied as a two-dimensional printed coil structure having a loop topology. The loop topology of the primary segment 202 is ideal for DC biasing of discrete electronic devices, allowing the placement of in-band tuning devices 212 at optimal locations along primary segment 202. Secondary segment 204 is preferably embodied as a two-dimensional printed coil structure having a meander loop topology.

As seen at enlargement 220, primary and secondary segments 202 and 204 are preferably galvanically isolated from each other and inductively coupled by their interleaved portions. The impedance match of the antenna structure is controlled by the intensity of the inductive coupling between the primary and secondary segments, which intensity is in turn controlled by the geometric characteristics of the interleaved features of the primary and secondary segments, such as number, density and separation of the interleaved features.

It is noted that the primary and secondary segments 202 and 204 of the present invention do not require significant spatial separation from the PCB groundplane 208. Conventional compact unbalanced electrically small loop and monopole antennas typically exhibit extremely low impedance at resonance when deployed close to the groundplane, making them difficult to match to standard 50 Ohm hardware. The inductively coupled topology of the present invention acts to significantly increase the typically low resonant antenna impedance of the loop structure, thereby enabling effective impedance matching to the transceiver hardware (typically 50 Ohms). This enhanced impedance matching ultimately augments the conversion of bound signal energy from the wireless device into freely propagating electromagnetic waves in the user's operating environment, creating an improved communications channel for the entire wireless system of which the antenna of the present invention is a part.

This feature of the present invention is particularly advantageous for lower frequencies of operation, where, with an appropriately designed matching circuit at the feed 214, the antenna is capable of providing wide operating bandwidths without a significant separation between the primary and secondary segments 202 and 204 and the ground 208. For Quad-Band cellular antenna designs, the position of the band selection hardware 210 permits the antenna to alternate between “Low Band” [GSM850+GSM 900] and “High Band” [GSM1800+GSM1900] operation.

Reference is now made to FIG. 3, which is a top view of the antenna of FIG. 1 formed in two dimensions on a printed circuit board, the antenna including primary and secondary inductively coupled conductive segments, the primary segment having a loop structure and the secondary segment having a monopole structure.

As seen in FIG. 3, the antenna comprises two conductive segments: primary segment 302 and secondary segment 304. Primary and secondary segments 302 and 304 are printed on a PCB substrate 306 and are each in contact with a PCB ground 308. Band selection hardware 310 is preferably located along secondary segment 304. In-band tuning devices 312 are preferably located along primary segment 302. The operation of band selection hardware 310 and in-band tuning devices 312 is as described in reference to the parallel features of FIG. 1. The antenna is fed by a single feed 314 preferably located at the start of the primary segment 302.

The embodiment of the present invention shown in FIG. 3 shares all of the features and advantages of the embodiments described in reference to FIGS. 1 and 2, with the exception that in the embodiment shown in FIG. 3 the secondary segment 304 is preferably embodied as a two-dimensional printed coil structure having a meander monopole topology as opposed to the meander loop topology of the secondary segment 204 of FIG. 2. The monopole structure of secondary segment 304 is best seen at enlargement 320 of FIG. 3, where a separation 322 is present between secondary segment 304 and PCB ground 308. The effect of the monopole structure of secondary segment 304 is to lower the operating frequency of the antenna.

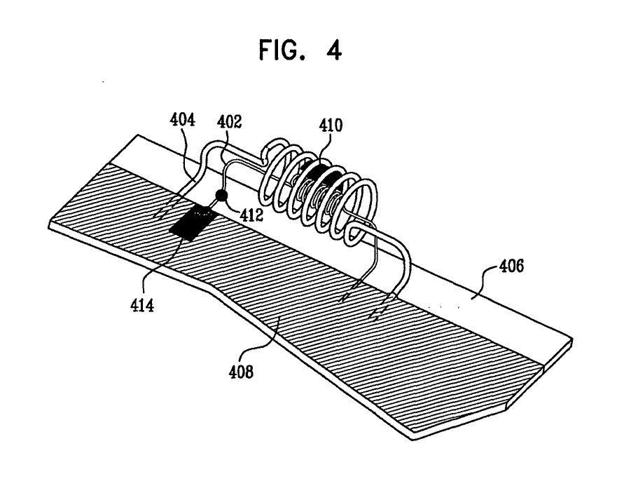

Reference is now made to FIG. 4, which is a side view of the antenna of FIG. 1 formed in three dimensions on a dielectric substrate, the antenna including primary and secondary inductively coupled conductive segments both having a coiled loop structure.

As seen in FIG. 4, the antenna comprises two coiled conductive segments: primary coil 402 and secondary coil 404. Primary and secondary coils 402 and 404 are each preferably embodied as three-dimensional loops on a PCB substrate 406 and are each in contact with a PCB ground 408. Band selection hardware 410 is preferably located along secondary coil 404. An in-band tuning device 412 is preferably located along primary coil 402. The antenna is fed by a single feed 414 preferably located at the start of the primary coil 402.

The embodiment of the present invention shown in FIG. 4 shares all of the features and advantages of the embodiments described in reference to the earlier figures, with the structural difference that the primary and secondary coils of this embodiment are preferably formed in three dimensions, in contrast to the primary and secondary segments of the embodiments of FIGS. 2 and 3, which are preferably formed as two dimensional printed features on the surface of a PCB.

It will be appreciated by persons skilled in the art that the present invention is not limited by what has been particularly claimed hereinbelow. Rather the scope of the present invention includes various combinations and subcombinations of the features described hereinabove as well as modifications and variations thereof as would occur to persons skilled in the art upon reading the foregoing description with reference to the drawings and which are not in the prior art.

1. An inductively coupled band selectable and tunable antenna comprising:
a first conductive segment;
a second conductive segment interleaved with said first conductive segment and inductively coupled to said first conductive segment;
tuning hardware located along said first conductive segment; and
band selection hardware located along said second conductive segment.

2. The antenna of claim 1 wherein said first conductive segment has a loop structure.

3. The antenna of claim 1 wherein said second conductive segment has a loop structure.

4. The antenna of claim 3 wherein said first and second conductive segments comprise three-dimensional coils.

5. The antenna of claim 1 wherein said second conductive segment has a monopole structure.

6. The antenna of claim 1 wherein said band selection hardware comprises at least one radio frequency switch.

7. The antenna of claim 1 wherein said tuning hardware comprises at least one variable capacitor.

8. The antenna of claim 1 wherein the strength of the inductive coupling between said first conductive segment and said second conductive segment is controlled by the geometry of the interleaved portions of said first and second conductive segments.

9. The antenna of claim 1 wherein said first and second conductive segments are printed on a printed circuit board.

10. The antenna of claim 1 wherein the antenna is fed by a feed located at the start of said first conductive segment.

11. The antenna of claim 1 wherein said first conductive segment is galvanically isolated from said second conductive segment.
